(19) United States
(12) Patent Application Publication
(10) Pub. No.: US 2005/0211118 A1
(43) Pub. Date: Sep. 29, 2005

(54) Inking device for printing units of rotary printing machines

(76) Inventors: Xaver Bachmeir, Haunswies (DE); Harald Lesti, Augsburg (DE); Robert Konrad, Augsburg (DE)

Correspondence Address: Thomas C Pontani;Cohen Pontani Lieberman & Pavane, 551 Fifth Avenue, Suite 1210, New York, NY, 10176, US

(21) Appl. No.: 10/510,379

(22) PCT Filed: Apr. 5, 2003
(86) PCT No.: PCT/EP03/03564

§ 371 Date: Oct. 5, 2004

(30) Foreign Application Priority Data
Apr. 9, 2002 (DE) 10215615.8

(51) Int. Cl. B41F 31/30

(52) U.S. Cl. 101/349.1; 101/147

(57) ABSTRACT

An inking unit for printing units of rotary presses is independent of the printing unit and is configured as a self-contained unit. The linking unit can be removed from the printing unit and has a dedicated drive for a plurality of rolls, the drive being arranged on side walls which are assigned to the inking unit.

The invention relates to an inking unit for printing units of rotary presses as claimed in claim 1.

EP 0 305 235 B1 has disclosed a sheet-processing offset printing press with a movable inking unit module, the inking unit module being driven by the drive of the printing unit via gear wheel connections.

The invention is based on the object of providing an inking unit which is independent of the printing unit and is configured as a self-contained unit.

According to the invention, the object is achieved in an inking unit of the generic type by using the features of the characterizing part of claim 1. Refinements emerge from the subclaims and from the description in conjunction with the drawings.

It is an advantage of the invention that the inking unit, which is configured as a structurally self-contained unit, is configured as a cassette with its own side walls and crossmembers. It is particularly advantageous that the drives for rolls, distributors and ink ductor are integrated in the inking unit. Furthermore, it is significant that a dampening unit can be integrated in the inking unit, the drives which belong to the dampening unit, for example the drive of the dampening solution dip roll, likewise being integrated in the inking unit. The inking unit can also be configured with valve islands, in order for it to be possible to connect the inking unit or the dampening unit integrated in the latter to an ink supply, dampening solution supply and/or pressure medium supply.

The inking unit can be installed in the printing unit and dismantled simply and in a short time for maintenance, service and exchanging.

It is significant that it is possible to completely preassemble and test the inking unit configured in such a way.

One significant advantage is that the inking unit can be operated outside the printing unit for test or service purposes in an apparatus which has identical or similar mechanical, fluid and electrical interfaces to the printing unit.

It should be mentioned, in particular, that the inking unit can be replaced by a structurally identical inking unit while maintenance and repair work is being performed, in order to increase the availability of the machine.

The inking unit according to the invention has simple mechanical interfaces via centering elements with or without a locking means to a receptacle, the receptacle being arranged fixedly or movably about at least one axis in the printing unit.

In order to perform other printing methods, it is possible to arrange an inking unit for toner printing, flexographic printing or gravure printing, instead of the inking unit for offset printing, on the receptacle, the inking units all having identical mechanical interfaces. Furthermore, the offset printing inking units can also vary to the effect that zonal inking units, zoneless inking units, inking units for heatset inks, coldest inks, sheet printing inks and radiation-curable inks can be exchanged for one another, the inking units all having identical mechanical interfaces. A varnishing unit can also be arranged in the receptacle instead of the inking unit, the varnishing unit having identical mechanical interfaces as the abovementioned inking units.

Furthermore, the inking unit has fluid interfaces which are easy to operate and simply configured for pneumatics, hydraulics, ink supply, dampening solution circuit and temperature control means, the fluid interfaces being configured, for example, with quick-action couplings.

The inking unit is configured with electrical interfaces which are easy to operate and simply configured for drives (motors), machine control and field bus connection (data bus connection), the electrical interfaces being, for example, plug-in connections.

It is significant that the inking unit can be installed and dismantled without tools by means of apparatuses which are attached to a base or a crane in the printing unit or in the abovementioned testing and service apparatus.

The invention is to be explained in greater detail in the following text using an exemplary embodiment. In the drawing, in diagrammatic form:

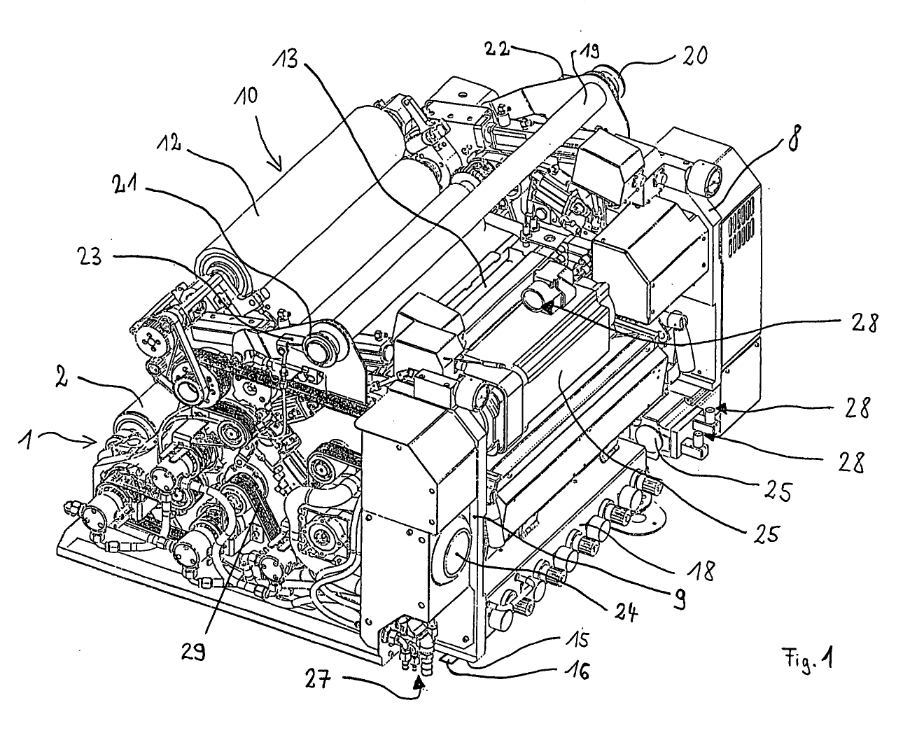

FIG. 1 shows an inking unit according to the invention, and

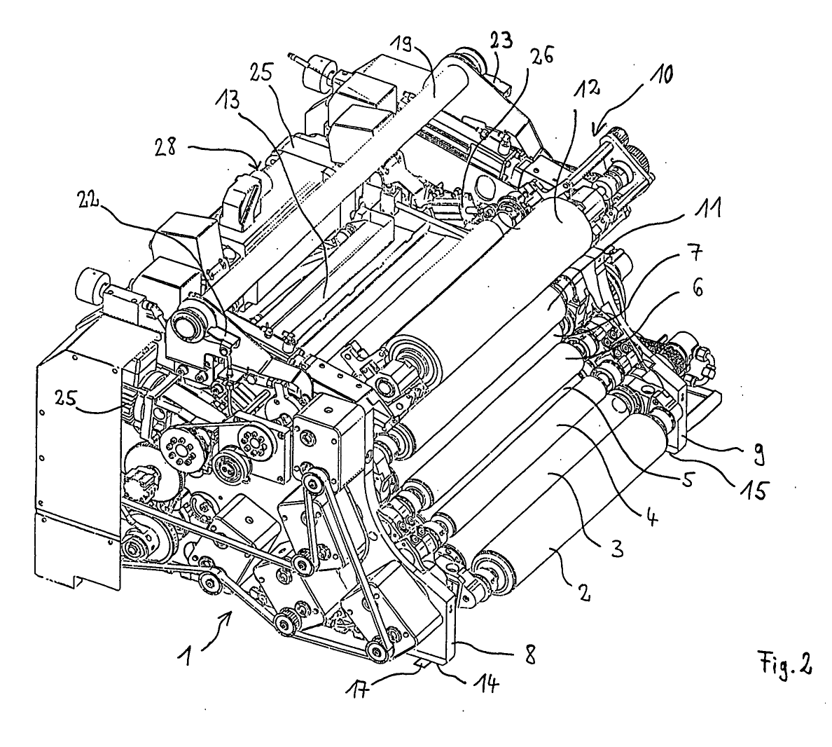

FIG. 2 shows a further view from FIG. 1.

FIG. 1 and FIG. 2 show an inking unit 1, whose rolls 2 to 7, for example applicator rolls and distributor rolls, are mounted between side walls 8; 9. Additionally, a dampening unit 10 can also be integrated in the inking unit 1, which dampening unit 10 diagrammatically comprises the rolls 11; 12, for example applicator rolls and distributor rolls, and the dampening solution fountain 13, the rolls 11; 12 and the dampening solution fountain 13 being mounted between the side walls 8; 9.

The side walls 8; 9 are configured with guide elements 14; 15 and stops 16; 17, by means of which the inking unit 1 (not shown in greater detail) can be arranged positionally correctly and such that it can be pushed onto guide elements and/or latching elements or positioning apparatuses arranged in side walls of the printing unit. The inking unit 1 with its guide elements 14; 15 and its stops 16; 17 (not shown in greater detail) can be attached, for example, to a receptacle apparatus which is arranged in the printing unit or on an apparatus situated outside the printing unit for performing test, repair and/or service work. The receptacle apparatus can be configured as a cross slide, as already described in the prior patent application DE 100 08 215.7.

The inking unit 1 with its guide elements 14; 15 and its stops 16; 17 can additionally be moved against positioning apparatuses arranged on the receptacle apparatus. Said positioning apparatus can be configured with a locking means (not shown in greater detail).

Using the positioning apparatus, the inking unit 1 is moved into a correct position with respect to the impression cylinders, or this correct position is secured. The ink fountain 18 and a stop element 19 are arranged between the side walls 8; 9. The stop element 19 is configured with roll elements 20; 21 at its ends. An apparatus which is attached to a base or a crane for transporting the inking unit 1 can be arranged on the stop element 19 and/or its roll elements 20, 21 (not shown in greater detail). The inking unit 1 can be installed and dismantled without tools, apart from the use of the transport apparatus because of the high weight of the inking unit 1. In order to dismantle the inking unit 1, the stops 16, 17 must be unlocked by means of an unlocking means 22; 23 if said stops 16; 17 were locked at the positioning apparatus.

The inking unit 1 is configured with at least one drive motor 24 which is mounted, for example, on the side wall 9. The rolls 2 to 7; 11; 12 can be driven by the drive motor 24, for example via a belt 29 or some other mechanisms or mechanical drive connections. Further drives, for example servo drives 25 and/or operating cylinders 26 operated by pressure medium, can also be arranged on the side walls 8; 9. The rolls 2 to 7; 11; 12, as described in the patent application PB 04546 submitted in parallel with this document, can be adapted to various impression cylinder diameters, for example in terms of their position, by means of the servo drives 25 or the operating cylinders 26. For example, the stroke of the rolls 2 to 7; 11; 12 which are configured as distributor rolls can be adjusted by means of the servo drives 25. The inking unit 1 is therefore configured with fluid interfaces 27 and/or interfaces 27 which conduct pressure medium and electrical interfaces 28 for operating and controlling the abovementioned drives. It is also possible to connect ink supply devices and/or dampening solution supply devices to the inking unit 1 via the interfaces 27. The energy supply and machine controller, in particular, are connected to the inking unit 1 or to the drives 24 to 26 integrated in the inking unit 1 via the electrical interfaces 28. The fluid interfaces 27 are configured, for example, with quick-action couplings. The electrical interfaces 28 are configured, for example, as plug-in connections.

### LIST OF REFERENCE SYMBOLS

1 Dampening unit
2 Roll
3 Roll
4 Roll
5 Roll
6 Roll
7 Roll
8 Side wall
9 Side wall
10 Dampening unit
11 Roll
12 Roll
13 Dampening solution fountain
14 Guide
15 Guide
16 Stop
17 Stop
18 Ink fountain
19 Stop element
20 Roll element
21 Roll element
22 Unlocking means
23 Unlocking means
24 Drive
25 Servo drive
26 Operating cylinder
27 Interface
28 Interface
29 Belt

1-11. (canceled)

12. An inking unit for a printing unit of a rotary printing press, said inking unit being removably receivable in the printing unit and comprising side walls, a plurality of rolls arranged between said side walls, and a dedicated drive mounted on at least one of said side walls of said inking unit for driving said plurality of rolls.

13. The inking unit of claim 12, further comprising a damping unit.

14. The inking unit of claim 13, wherein said damping unit comprises damping rolls said dedicated drive is operatively arranged for driving said dampening rolls.

15. The inking unit of claim 12, wherein said plurality of rolls comprise one of distributor rolls and applicator rolls.

16. The inking unit of claim 12, further comprising guides and stops, said inking unit configured as a cassette that is insertable into and removable from the printing unit by said guides and positionable in the printing unit using said stops.

17. The inking unit of claim 12, further comprising electrical interfaces for at least one of power, control, and data bus connections.

18. The inking unit of claim 12, further comprising interfaces for at least one of pressure medium supply, ink supply, dampening solution supply, and temperature control connections.

19. The inking unit of claim 12, further comprising at least one of a servo drive and a pressure medium operated operating cylinder.

20. The inking unit of claim 12, wherein said inking unit is installable in and removable from the printing unit without tools.

21. The inking unit of claim 12, wherein said inking unit is removable from the printing unit and operable in a further apparatus.

22. The inking unit of claim 21, wherein said inking unit is operable in the further apparatus that has compatible mechanical, fluid and electrical connections.
